(19) United States
(12) Patent Application Publication
(10) Pub. No.: US 2007/0250897 A1
(43) Pub. Date: Oct. 25, 2007

(54) System and method of providing selectable video content

(75) Inventor: Larry B. Pearson, San Antonio, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/389,838

(22) Filed: Mar. 27, 2006

(51) Int. Cl. H04N 5/445; H04N 7/16; G06F 13/00; G06F 3/00

(52) U.S. Cl. 725/135; 725/37; 725/38; 725/52

(57) ABSTRACT

A system and method of providing selectable video content is disclosed. In a particular embodiment, the method includes receiving a selection of a first mnemonic input at a set-top box device. The method also includes receiving a plurality of numeric input selections at the set-top box device, where each of the plurality of numeric input selections corresponds to at least one character. The method also includes determining a channel name based on a sequence of the plurality of numeric input selections.

### FIELD OF THE DISCLOSURE

The present disclosure is generally related to providing selectable video content.

### BACKGROUND

Television service providers offer viewers a variety of movie and television programming. Advances in cable, satellite, and other technologies allow television service providers to offer their customers hundreds of channels. Additionally, users can often select from multiple channels that show similar content, such as educational content, sports content, news content, or movie content. Users can select channels that they wish to view, for example, by using an interactive program guide or by entering a channel number on a remote control or keypad associated with a set-top box device.

The volume of potential programs and channels can make navigating to a desired program or channel difficult. Users may not remember the channel numbers associated with various networks. Moreover, users who travel to different cities may be forced to re-learn a different channel sequence than they use at home. This makes direct selection of a channel or program difficult. Hence, there is a need for an improved system and method of providing video content.

### BRIEF DESCRIPTION OF THE DRAWINGS

FIG. 1 is a block diagram illustrating a particular embodiment of a system to provide selectable video content;

FIG. 2 is a block diagram illustrating a particular embodiment of a system to select video content;

FIG. 3 is a flow diagram illustrating a particular embodiment of a method of providing selectable video content;

FIG. 4 is a diagram illustrating a particular embodiment of a channel map;

FIG. 5 is a diagram illustrating a particular embodiment of a graphical user interface (GUI) to provide selectable video content;

FIG. 6 is a diagram illustrating a second particular embodiment of a graphical user interface (GUI) to provide selectable video content; and

FIG. 7 is a diagram of an illustrative embodiment of a general computer system.

### DETAILED DESCRIPTION OF THE DRAWINGS

A system to provide selectable video content is disclosed and includes a processor and a memory device accessible to the processor. The memory device includes a mnemonic module executable by the processor to receive a mnemonic input selection and a plurality of numeric input selections. The memory device includes a mapping module executable by the processor to determine a channel name based on a sequence of the plurality of numeric input selections, where each of the plurality of numeric input selections corresponds to at least one character.

In another embodiment, a method of providing selectable video content is disclosed and includes receiving a selection of a first mnemonic input at a set-top box device. The method also includes receiving a plurality of numeric input selections at the set-top box device, where each of the plurality of numeric input selections corresponds to at least one character. The method also includes determining a channel name based on a sequence of the plurality of numeric input selections.

In another embodiment, a computer program embedded in a computer-readable medium is disclosed and includes instructions to communicate with a keypad to receive a mnemonic key selection and a plurality of numeric key selections. The computer program also includes instructions to determine a channel name based on a sequence of the plurality of numeric key selections, where each of the plurality of numeric key selections corresponds to at least one character.

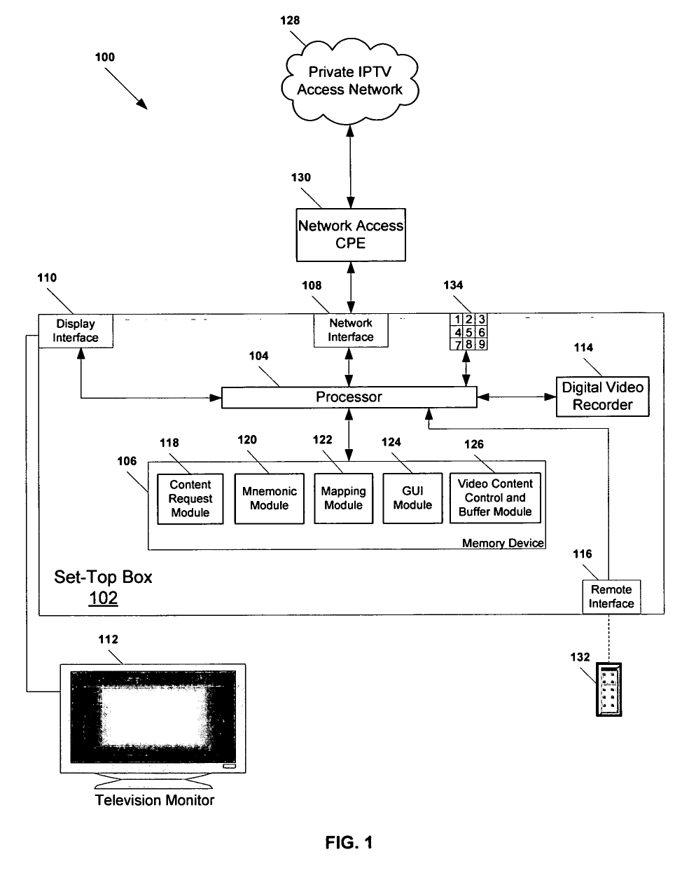

Referring to FIG. 1, an embodiment of a system to provide selectable video content is illustrated and designated generally at 100. The system includes a set-top box 102 that contains a processor 104 and a memory device 106 that is accessible to the processor 104. The processor 104 communicates with a network interface 108. Further, the processor 104 communicates with a display interface 110, such as a television interface, through which the set-top box device 102 can communicate video content, prompts, graphical user interfaces, or other content to an external display device, such as a television monitor 112. The processor 104 can communicate with an internal video storage device, such as a digital video recorder (DVR) 114. In addition, the processor 104 can communicate with a remote control device 132, via a remote control interface 116. The processor 104 can also communicate with a keypad device 134 integrated with the set-top box 102.

In an illustrative, non-limiting embodiment, the processor 104 can communicate with an external access network, such as an Internet Protocol Television (IPTV) access network 128, via the network interface 108. In a particular embodiment, network access customer premises equipment (CPE) 130 can facilitate communication between the network interface 108 and the IPTV access network 128. The network access CPE 130 can include a router, a local area network device, a modem, such as a digital subscriber line (DSL) modem, any other suitable device for facilitating communication between the network interface 108 of the set-top box device 102 and the IPTV access network 128, or any combination thereof.

In a particular embodiment, the memory device 106 can include a content request module 118 that is executable by the processor 104 to receive a request for video content from a user via the remote control device 132 or the keypad 134. For example, the request can be a channel change request or a video-on-demand request. The content request module 118 can be executable by the processor 104 to request and receive the video content from a server of an IPTV system via the IPTV access network 128. In an illustrative, non-limiting embodiment, the request can be ajoin command to be added to a multicast group of a channel.

Further, the memory device 106 can include a mnemonic module 120 that is executable by the processor 104 to communicate with the remote control device 132, for example, to receive a first mnemonic input selection, such as a mnemonic key selection. In addition, the mnemonic module 120 is executable by the processor 104 to receive a plurality of numeric input selections, such as numeric key selections, from the remote control device 132. In one embodiment, the mnemonic module 120 can be executable by the processor 104 to receive a ‘SELECT’ input selection, a second mnemonic input selection, or other second input selection after the plurality of numeric input selections. The first mnemonic input selection and the second input selection can indicate that numeric key selections received by the set-top box 102 between the two commands are to be used to determine a channel name or a program title.

In a particular embodiment, the set-top box 102 determines a channel name based on a sequence of the numeric key selections. For example, the user can press 6-2-2 to indicate N-B-C, or 3-7-7-6 to indicate E-S-P-N. The mnemonic module 120 can translate the numeric key selections into one or more character or letter combinations by equating the number 2 with A, B, or C; by equating 3 with D, E, or F; 4 with G, H, or I; and so on. Further, the mnemonic module 120 can be executable by the processor 104 to compare the letter combinations with a channel map stored in a mapping module 122 and to determine whether one or more of the letter combinations correspond with an available channel name.

In an illustrative embodiment, if one of the character or letter combinations corresponds to a channel name, the mnemonic module 120 can be executable by the processor 104 to instruct the content request module 118 to request video content shown by the channel. Alternatively, if more than one of the letter combinations correspond to channel names, the mnemonic module 120 can be executable by the processor to instruct a graphical user interface (GUI) module 124 to transmit a GUI or other prompt to the television monitor 112 presenting the user with a list of selectable channels that match the sequence of numeric key selections received at the set-top box 102. A selection of a channel name from the list can be received at the set-top box 102, and the GUI module 124, mnemonic module 120, or any combination thereof, can instruct the content request module 118 to request video content of the selected channel.

In another particular embodiment, the mnemonic module 120 can be executable by the processor 104 to determine a program title based on the sequence of the numeric key selections. For example, the user can press 5-6-7-8 to indicate L-O-S-T, or 4-3-6-5 to indicate I-D-O-L. Further, the mnemonic module 120 can be executable by the processor 104 to compare the letter combinations corresponding to the sequence of numeric key selections with letters of one or more program titles in a program map stored in the mapping module 122 and to determine whether one or more of the letter combinations correspond with a program title, such as Lost or American Idol.

In an illustrative embodiment, if one of the character or letter combinations corresponds to a program title, the mnemonic module 120 can be executable by the processor 104 to determine a channel on which the program is shown and to instruct the content request module 118 to request video content shown by the channel. Alternatively, if more than one of the letter combinations correspond to program titles, the mnemonic module 120 can be executable by the processor to instruct a graphical user interface (GUI) module 124 to transmit a GUI or other prompt to the television monitor 112 presenting the user with a list of selectable program titles that match the sequence of numeric key selections received at the set-top box 102. A selection of a program title from the list can be received at the set-top box 102, and the GUI module 124, mnemonic module 120, or any combination thereof, can instruct the content request module 118 to request video content of the channel showing the program.

The memory device 106 can also include a video content control and buffer module 126 that is executable by the processor 104 to receive video content requested by a user and to buffer the video content before transmitting it to the display interface 110, in order to prevent underflow.

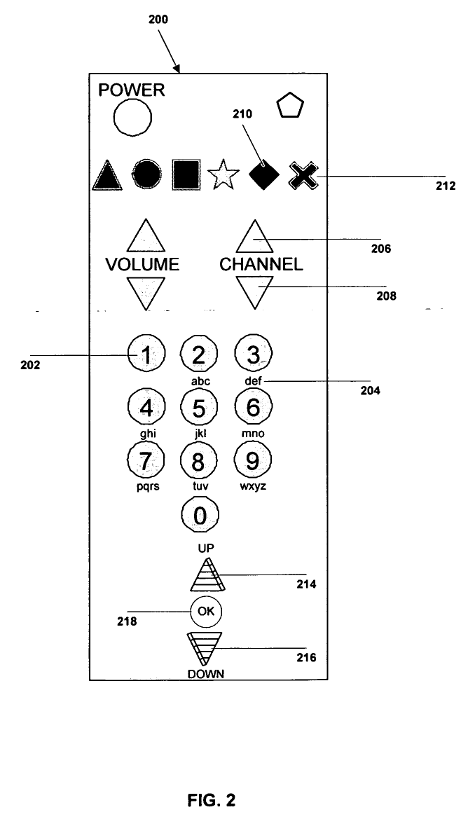

Referring to FIG. 2, a particular embodiment of a remote control device configured to select video content is illustrated and designated generally at 200. The remote control device 200 includes a keypad having at least one numeric key 202. In addition, the remote control device 200 can include character or letter designations 204 that correspond to each numeric key 202. The remote control device 200 can also include sequential channel change keys, such as a channel up key 206 and a channel down key 208.

Further, the remote control device 200 can include one or more custom keys that can be programmed by the user, a service provider, or any combination thereof, to communicate particular commands. For example, the remote control 200 can include a first mnemonic key 210 that a user can press before using the numeric keys 202 to communicate letters 204, and to signify that an intended character or letter combination has been completed. In another embodiment, the remote control 200 can include a first mnemonic key 210 that a user can press before using the numeric keys 202 to communicate letters 204 and a second mnemonic key 212, an ‘OK’ key 218, or other key that a user can press to signify that an intended character or letter combination has been completed.

In an illustrative embodiment, a user can press the first mnemonic key 210 to indicate that the user will enter a sequence of numeric key selections that corresponds to a channel name. For example, the user can press 6-2-2 to indicate N-B-C, or 3-7-7-6 to indicate E-S-P-N. When the user enters all intended numeric key selections, the user can press the first mnemonic key 210 again, or a second mnemonic key 212, to indicate that the sequence of numeric key selections has been completed. In a particular embodiment, a set-top box device receiving key selections from the remote control device 200 can determine one or more channel names based on the letter combination indicated by the numeric key selections issued between selection of the first mnemonic key 210 and selection of the second mnemonic key 212.

In another embodiment, the user can use the numeric keys 202 to enter characters or letters corresponding to a program title. For example, the user can press 5-6-7-8 to indicate L-O-S-T, or 4-3-6-5 to indicate I-D-O-L. When the user enters all intended numeric key selections, the user can press the first mnemonic key 210 again, or a second mnemonic key 212. In a particular embodiment, a set-top box device receiving key selections from the remote control device 200 can determine one or more program titles based on the character or letter combination indicated by the numeric key selections issued between selection of the first mnemonic key 210 and selection of the second mnemonic key 212.

If the character or letter combinations corresponding to a sequence of numeric key selections correspond to more than one program title or more than one channel name, the set-top box can transmit a graphical user interface (GUI) or other prompt to a television monitor presenting the user with a list of selectable program titles or channel names. A user can select a program title or channel name from the list using an up key 214, down key 216, ‘OK’ key 218, or any combination thereof.

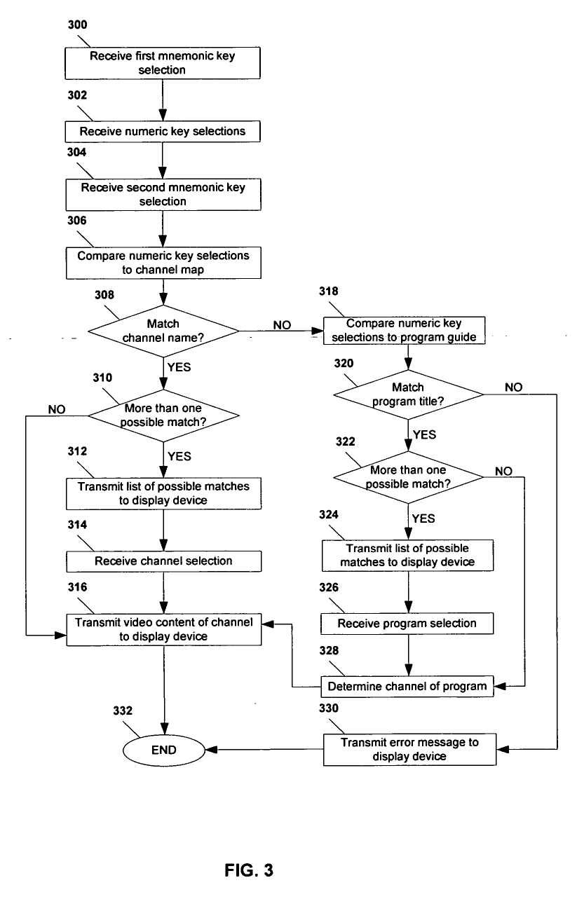

Referring to FIG. 3, a particular embodiment of a method of providing selectable video content is illustrated. At block 300, a set-top box device receives a first mnemonic key selection from a keypad. In an illustrative embodiment, the set-top box device can receive the mnemonic key selection from a user via a keypad of the set-top box device or via a keypad of a remote control device communicating with the set-top box device. Moving to block 302, the set-top box can receive a plurality of numeric key selections from the keypad. In a particular embodiment, the method can proceed to block 304, and the set-top box device can receive a second mnemonic key selection indicating that the user has completed an intended sequence of numeric key selections. For example, the set-top box device can receive a first mnemonic key selection, followed by selections of numeric keys 3-6-2, followed by a second mnemonic key selection.

Continuing to block 306, in a particular embodiment, the set-top box device can compare a sequence of the numeric key selections with a channel map stored at the set-top box device. Moving to decision step 308, the set-top box device determines whether the sequence of the numeric key selections matches names of any available channels in the channel map. If the set-top box determines that the sequence of numeric key selections corresponds to one or more available channel names, the method proceeds to decision step 310. For example, the set-top box can determine that a sequence of 3-6-2 corresponds to the Fox News Channel (FNC).

In a particular embodiment, at decision step 310, the set-top box device can determine whether more than one available channels match the sequence of numeric key selections. If the set-top box determines that only one channel name matches the sequence of numeric key selections, the method proceeds to block 316, and the set-top box device transmits video content of the channel to a display device. The method then terminates at 332. In an illustrative embodiment, the set-top box device can request and receive the video content from a video head-end office of a cable network, a satellite network, or an Internet Protocol Television (IPTV) network.

Returning to decision step 310, if the set-top box determines that the sequence of numeric key selections corresponds to more than one available channel, the method proceeds to block 312. For instance, the set-top box can determine that a sequence of 3-6-2 matches Fox Movie Channel (FMC) and Fox News Channel (FNC). At block 312, the set-top box device transmits a graphical user interface (GUI) or other prompt to the display device that includes a list of selectable channel names matching the sequence of numeric key selections. Continuing to block 314, the set-top box device receives a selection of one of the selectable channel names. Moving to block 316, the set-top box device transmits video content of the channel to a display device.

Returning to decision step 308, in a particular embodiment, if the sequence of numeric key selections does not match an available channel name in the channel map, the method can advance to block 318. At block 318, the set-top box device can compare the sequence of numeric key selections to a program map stored at the set-top box device or to a program guide that is stored or received at the set-top box device. In an illustrative embodiment, the program guide can be an interactive electronic program guide that is received at or generated by the set-top box device. Moving to decision step 320, the set-top box device determines whether the sequence of the numeric key selections matches any program titles in the program map or program guide. If the set-top box determines that the sequence of numeric key selections does not correspond to any program titles, the method advances to block 330, and the set-top box device can transmit an error message to the display device. The method then terminates at 332.

Conversely, if the set-top box device determines that the sequence of numeric key selections corresponds to one or more program titles, the method proceeds to decision step 322. For example, the set-top box can determine that a sequence of 2-7-4 corresponds to ‘CSI.’ At decision step 322, the set-top box determines whether more than one program titles match the sequence of numeric key selections. If the set-top box determines that only one channel name matches the sequence of numeric key selections, the method proceeds to block 328, and the set-top box device determines a channel on which the program is shown. The method then moves to block 316, and the set-top box device transmits video content of the channel to a display device. The method then terminates at 332.

Returning to decision step 322, if the set-top box determines that multiple program titles match the sequence of numeric key selections, the method proceeds to block 324. For example, the set-top box can determine that numeric key selections of 2-7-4 corresponds to program titles of ‘CSI,’ ‘CSI: Miami,’ or ‘CSI: NY.’ At block 324, the set-top box device transmits a graphical user interface (GUI) or other prompt to the display device that includes a list of selectable program titles matching the sequence of numeric key selections. Continuing to block 326, the set-top box device receives a selection of one of the selectable program titles. Moving to block 328, the set-top box device determines a channel on which the selected program is shown. The method then moves to block 316, and the set-top box device transmits video content of the channel to a display device. The method then terminates at 332.

Though the aspects of the disclosed method has been presented in a certain order, for ease of description, certain portions of the method may be performed in a different order or simultaneously.

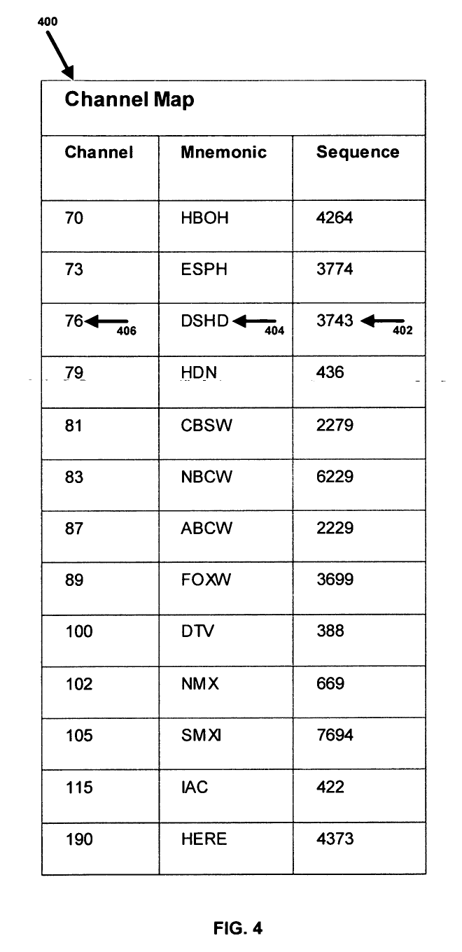

Referring to FIG. 4, an illustrative embodiment of a channel map is illustrated and designated generally at 400. The channel map 400 includes a plurality of numeric key sequences 402. Each numeric key sequence 402 is mapped to one or more mnemonics 404, such as channel names. Additionally, each numeric sequence 402, mnemonic 404, or any combination thereof, can be mapped to a channel number 406. In a particular embodiment, the channel map 400 can be stored in a memory of a set-top box device. The set-top box device can compare a sequence of numeric key selections to the channel map to determine whether the sequence corresponds to an available channel. If the sequence corresponds to an available channel, the set-top box can transmit video content of the channel to a display device. For example, if the set-top box device receives a sequence of numeric key selections of 3-7-4-3, the set-top box can determine based on the channel map 400 that the sequence corresponds to a channel name of DSHD. In an illustrative embodiment, the set-top box device can then request video content of a channel number 76 from a video head-end office and can transmit the video content to the display device.

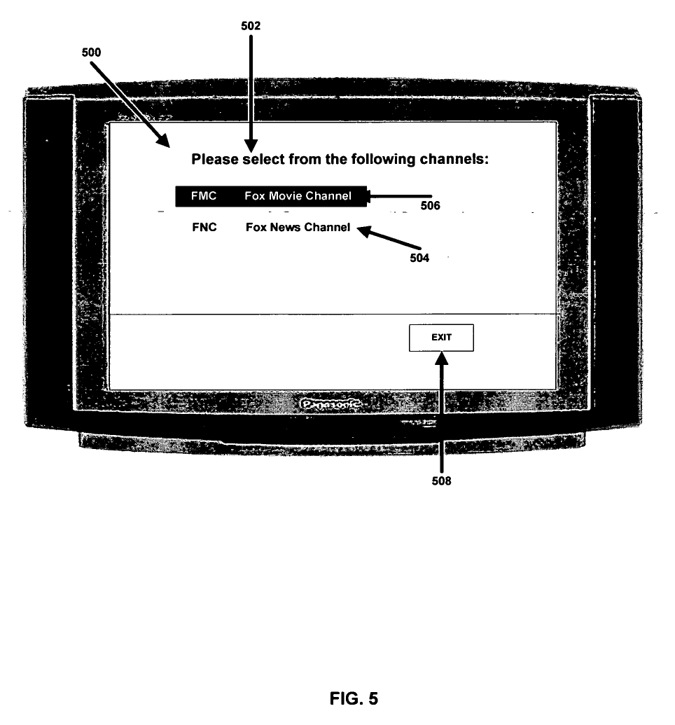

Referring to FIG. 5, a particular embodiment of a graphical user interface (GUI) to provide selectable video content is illustrated and designated generally at 500. The GUI 500 can include a list of multiple channels that correspond to a sequence of numeric key selections receive at a set-top box device. For instance, if the set-top box receives a sequence of numeric key selections of 3-6-2, the set-top box device can determine that the sequence of numeric key selections corresponds to both Fox Movie Channel (FMC) and Fox News Channel (FNC). The set-top box device can then transmit the GUI 500 to a display device. In an illustrative embodiment, the GUI 500 can include a prompt 502 requesting that a user select from the available channel names 504 listed in the GUI 500. The user can select from the available channel names 504, for example, by using arrow keys on a keypad to manipulate a highlight bar 506 and by pressing a ‘SELECT’ key, ‘OK’ key, or similar key when a desired channel name 504 is highlighted. In a particular embodiment, the GUI 500 can also include an ‘EXIT’ indicator 508 that a user can select to exit the GUI 500, return to a previous GUI, return to programming, or any combination thereof.

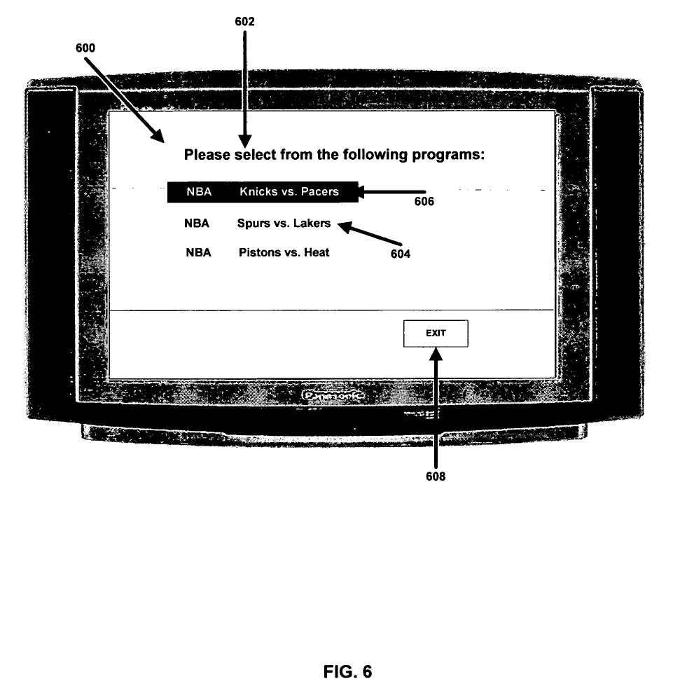

Referring to FIG. 6, a particular embodiment of a graphical user interface (GUI) to provide selectable video content is illustrated and designated generally at 600. The GUI 600 can include a list of multiple program titles that correspond to a sequence of numeric key selections receive at a set-top box device. For instance, if the set-top box receives a sequence of numeric key selections of 6-2-2, the set-top box device can determine that the sequence of numeric key selections corresponds to more than one National Basketball Association (NBA) games. The set-top box device can then transmit the GUI 600 to a display device. In an illustrative embodiment, the GUI 600 can include a prompt 602 requesting that a user select from the program titles 604 listed in the GUI 600. The user can select from the program titles 604, for example, by using arrow keys on a keypad to manipulate a highlight bar 606 and by pressing a ‘SELECT’ key, ‘OK’ key, or similar key when a desired program title 604 is highlighted. In a particular embodiment, the GUI 600 can also include an ‘EXIT’ indicator 608 that a user can select to exit the GUI 600, return to a previous GUI, return to programming, or any combination thereof.

In conjunction with the configuration of structure described herein, the system and method disclosed provide selectable video content by allowing a user of a set-top box device to request channels by name, such as TNT, ESPN, ABC, etc. In a particular embodiment, numeric keys on a keypad of the set-top box device or a remote control can correspond to particular characters or letters. In an illustrative embodiment, the user can select a mnemonic key and enter a plurality of numeric key selections. The set-top box device can determine whether a sequence of the numeric key selections corresponds to a channel name by referencing a channel map stored at the set-top box device. If the sequence matches a channel name, the set-top box device can transmit video content of the channel to a display device. In another particular embodiment, the set-top box device can determine whether the sequence of numeric key selections corresponds to at least a portion of a program title by referencing a program guide or program map. If the sequence matches a program title, the set-top box device can determine a channel on which the program is shown and transmit video content of the channel to a display device.

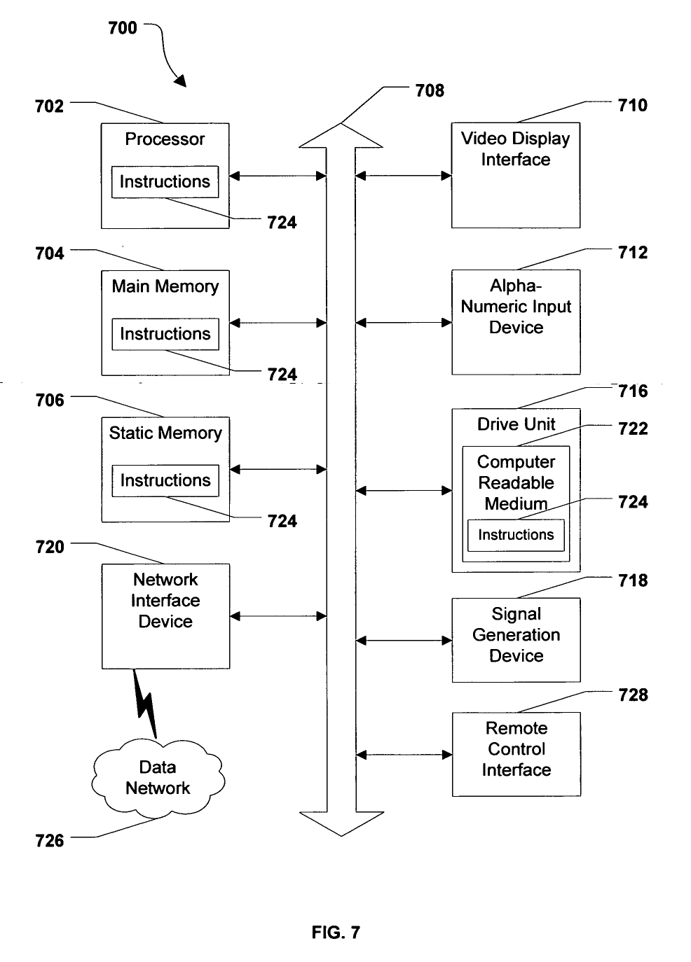

Referring to FIG. 7, an illustrative embodiment of a general computer system is shown and is designated 700. The computer system 700 can include a set of instructions that can be executed to cause the computer system 700, or a portion thereof, to perform any one or more of the methods or computer based functions disclosed herein. The computer system 700, or any portion thereof, may operate as a standalone device or may be a hardware or software module within a server or other device.

The computer system 700 can also be implemented as or incorporated into various other devices, such as the set-top box device illustrated in FIG. 1, or any other machine capable of executing a set of instructions (sequential or otherwise) that specify actions to be taken by that machine. In a particular embodiment, the computer system 700 can be implemented using electronic devices that provide audio, video or data communication. Further, while a single computer system 700 is illustrated, the term “system” shall also be taken to include any collection of systems or sub-systems that individually orjointly execute a set, or multiple sets, of instructions to perform one or more computer functions.

As illustrated in FIG. 7, the computer system 700 may include a processor 702, e.g., a central processing unit (CPU), a graphics-processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a remote control input, an input control panel, a keyboard, a mouse, a gaming station input, or one or more keys disposed on a set-top box device. The computer system 700 can also include a disk drive unit 716, or other secondary storage interface configured to receive a removable secondary storage medium. The computer can also include a signal generation device 718, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives instructions 724 responsive to a propagated signal, so that a device connected to a network 726 can communicate audio, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing selectable video content, the method comprising:
receiving a selection of a first mnemonic input at a set-top box device;
receiving a plurality of numeric input selections at the set-top box device, wherein each of the plurality of numeric input selections corresponds to at least one character; and
determining a channel name based on a sequence of the plurality of numeric input selections.

2. The method of claim 1, further comprising transmitting video content of a channel having the channel name to a display device coupled to the set-top box device.

3. The method of claim 1, further comprising receiving a selection of a second mnemonic input before determining the channel name.

4. The method of claim 1, wherein the selection of the mnemonic input and the plurality of numeric input selections are received from a remote control device communicating with the set-top box device.

5. The method of claim 1, wherein the selection of the mnemonic input and the plurality of numeric input selections are received via a keypad.

6. The method of claim 1, further comprising comparing the sequence of the plurality of numeric input selections to a channel map.

7. The method of claim 1, further comprising:
determining a plurality of channel names based on the sequence of the plurality of numeric input selections; and
transmitting a list of the plurality of channel names to a display device coupled to the set-top box device.

8. The method of claim 7, further comprising:
receiving a selection of the channel name at the set-top box device; and
transmitting video content of a channel having the channel name to the display device.

9. The method of claim 1, further comprising:
determining that the plurality of numeric input selections corresponds to a program title, wherein a program having the program title is shown on a channel having the channel name; and
transmitting video content of the channel having the channel name to a display device coupled to the set-top box device.

10. The method of claim 9, further comprising:
determining a plurality of program titles based on the sequence of the plurality of numeric input selections; and
transmitting a list of the plurality of program titles to a display device coupled to the set-top box device.

11. The method of claim 10, further comprising:
receiving a selection of the program title at the set-top box device; and
transmitting video content of a channel showing a program having the program title to a display device coupled to the set-top box device.

12. A set-top box, comprising:
a processor and a memory device accessible to the processor;
wherein the memory device includes a mnemonic module executable by the processor to receive a mnemonic input selection and a plurality of numeric input selections; and
wherein the memory device includes a mapping module executable by the processor to determine a channel name based on a sequence of the plurality of numeric input selections, wherein each of the plurality of numeric input selections corresponds to at least one character.

13. The set-top box of claim 12, wherein the mnemonic module is executable by the processor to communicate with a keypad to receive a selection of a select input before the channel name is determined.

14. The set-top box of claim 12, wherein the keypad is in a remote control device.

15. The set-top box of claim 12, wherein the set-top box device includes the keypad.

16. The set-top box of claim 12, wherein the mapping module includes a channel map.

17. The set-top box of claim 12, further comprising:
a user interface module executable by the processor to transmit a plurality of channel names to a display device coupled to the set-top box device; and
wherein the mapping module is executable by the processor to determine the plurality of channel names based on the sequence of the plurality of numeric input selections.

18. The set-top box of claim 12, wherein the mnemonic module is executable by the processor to determine that the plurality of numeric input selections corresponds to a program title and wherein a program having the program title is shown on a channel having the channel name.

19. The set-top box of claim 18, further comprising:
a user interface module executable by the processor to transmit a plurality of program titles to a display device coupled to the set-top box device; and
wherein the mapping module is executable by the processor to determine the plurality of program titles based on the sequence of the plurality of numeric input selections.

20. A computer program embedded in a computer-readable medium, the computer program comprising:
instructions to communicate with a keypad to receive a mnemonic key selection and a plurality of numeric key selections; and
instructions to determine a channel name based on a sequence of the plurality of numeric key selections, wherein each of the plurality of numeric key selections corresponds to at least one character.

21. The computer program of claim 20, further comprising instructions to communicate with the keypad to receive a second selection of the mnemonic key before the channel name is determined.

22. The computer program of claim 20, further comprising:
instructions to transmit a plurality of channel names to a display device coupled to the set-top box device; and
instructions to determine the plurality of channel names based on the sequence of the plurality of numeric key selections.
